(19) United States
(12) Patent Application Publication
(10) Pub. No.: US 2024/0061201 A1
(43) Pub. Date: Feb. 22, 2024

(54) MODULAR AND SCALABLE OPTICAL FIBER CABLE FIXATION, ENTRY, STORAGE, AND SPLICING SYSTEM PROVIDING EXPANDABILITY ON DEMAND

(71) Applicant: PPC BROADBAND, INC., East Syracuse, NY (US)

(72) Inventors: Stefan DONCHEV, Milton Keynes (GB); Jerin RAJ, East Syracuse, NY (US); Kim ERIKSEN, Tappernøje (DK); Afzal V. ABDULSALAM, East Syracuse, NY (US)

(73) Assignee: PPC BROADBAND, INC., East Syracuse, NY (US)

(21) Appl. No.: 18/234,576

(22) Filed: Aug. 16, 2023

Related U.S. Application Data
(60) Provisional application No. 63/398,503, filed on Aug. 16, 2022.

(51) Int. Cl. G02B 6/44

(52) U.S. Cl. CPC G02B 6/4452; G02B 6/4454

(57) ABSTRACT

A cable management device including: a base portion; and a side portion. The base portion may include an edge connecting portion at an edge of the base portion that may be structurally configured to removably connect to an edge connection portion of an other device; the base portion may include an edge connection portion at an edge of the base portion that may be structurally configured to removably connect to an edge connecting portion of the other device; the edge connecting portion may be structurally configured as a connection recess; the edge connection portion may be structurally configured as a connection tab; and the base portion and the side portion may be structurally configured to be removably connected to the other device to provide a modular and scalable cable management system that permits expandability on demand.

### CROSS-REFERENCE TO RELATED APPLICATION

This application claims the benefit of U.S. Provisional Application No. 63/398,503 filed Aug. 16, 2022, the disclosure of which is hereby incorporated by reference herein in its entirety.

### BACKGROUND

The present invention relates generally to optical fiber cable management. More particularly, the present invention relates to a system for fixing and storing optical fiber cables in an optical fiber cable management system (for example, a management system that includes cable splicing).

Conventional systems often provide little or no splice tray identification, difficult access to optical fibers, and difficult or non-existent expansion of capacity.

It may be desirable to provide systems that organize and store optical fibers before and after the splicing of the optical fibers.

### SUMMARY

The present disclosure provides a modular splicing and optical fiber management system that can be used in a wide range of products such as, for example, splice closures, multiple dwelling unit (MDU) enclosures, cabinets, optical distribution frame (ODF) panels, and other applications that require splicing of optical fibers. Embodiments are based on high density splice trays (cassettes), that are hinged and stacked on a back plate that is used for routing of the optical fibers to the splice trays. Additional parts of exemplary embodiments of the system include a fiber entry and storage plate which is used for storage and routing of the optical fibers, and a cable entry/attachment plate which is used for fixation of the optical fiber cable, stripping the jacket of the optical fiber cable, and routing the cable components to the fiber entry and storage plate. Embodiments provide a number of features which separately and together provide significantly better experience during optical fiber routing, optical fiber splicing, and subsequent management and maintenance of the system.

Embodiments provide a cable management device that may include a base portion, and a side portion. The base portion may include an edge connecting portion at an edge of the base portion that may be structurally configured to removably connect to an edge connection portion of an other device; the base portion may include an edge connection portion at an edge of the base portion that may be structurally configured to removably connect to an edge connecting portion of the other device; the edge connecting portion may be structurally configured as a connection recess; the edge connection portion may be structurally configured as a connection tab; the base portion is structurally configured as a base plate; the side portion may be structurally configured as a side wall; the side portion may extend at a positive angle from the base portion; and the base portion and the side portion may be structurally configured to be removably connected to the other device to provide a modular and scalable cable management system that may permit expandability on demand.

In particular embodiment, the base portion may include a securing portion that is structurally configured to receive a cable securing portion to secure an optical cable to the base portion.

In particular embodiment, the securing portion is structurally configured as a T-slot.

Particular embodiments further comprise: a fiber entry and retention portion that may include a guide portion that may be structurally configured to receive optical fibers entering the cable management device; a retention portion may extend from the guide portion and that may by structurally configured to retain the optical fibers in the fiber entry and retention portion; and a fiber storage portion that may be structurally configured to receive and store the optical fibers that have entered the cable management device.

In particular embodiment, the guide portion may be structurally configured as a guide wall.

In particular embodiment, the retention portion may be structurally configured as a retention tab.

In particular embodiment, the fiber storage portion may be structurally configured as a fiber spool.

Particular embodiments further comprise a side pathway portion that may be structurally configured to provide a path for optical fibers to pass from the base portion to an adjacent cable management device; a rear passage portion that may be structurally configured to allow passage of the optical fibers from a front side of the base portion to a rear side of the base portion; and a lower passage portion that may be structurally configured to allow passage of the optical fibers from the front side of the base portion to the rear side of the base portion.

In particular embodiment, the side portion may extend at a positive angle from the base portion.

In particular embodiment, the cable management device may be structurally configured as a cable fixation plate.

In particular embodiment, the cable management device may be structurally configured as a fiber entry and storage plate.

Embodiments provide a cable management device that may include a base portion and a side portion. The base portion may include an edge connecting portion at an edge of the base portion that may be structurally configured to removably connect to an edge connection portion of an other device; the base portion may include an edge connection portion at an edge of the base portion that may be structurally configured to removably connect to an edge connecting portion of the other device; the edge connecting portion may be structurally configured as a connection recess; the edge connection portion may be structurally configured as a connection tab; and the base portion and the side portion may be structurally configured to be removably connected to the other device to provide a modular and scalable cable management system that may permit expandability on demand.

In particular embodiment, the base portion may include a securing portion that may be structurally configured to receive a cable securing portion to secure an optical cable to the base portion.

In particular embodiment, the securing portion may be structurally configured as a T-slot.

Particular embodiments further may comprise a fiber entry and retention portion that may include a guide portion that may be structurally configured to receive optical fibers entering the cable management device; a retention portion may extend from the guide portion and that may be structurally configured to retain the optical fibers in the fiber entry and retention portion; and a fiber storage portion that may be structurally configured to receive and store the optical fibers that have entered the cable management device.

Particular embodiments may further comprise a side pathway portion that may be structurally configured to provide a path for optical fibers to pass from the base portion to an adjacent cable management device; a rear passage portion that may be structurally configured to allow passage of the optical fibers from a front side of the base portion to a rear side of the base portion; and a lower passage portion that may be structurally configured to allow passage of the optical fibers from the front side of the base portion to the rear side of the base portion.

In particular embodiment, the side portion may extend at a positive angle from the base portion.

In particular embodiment, the cable management device may be structurally configured as a cable fixation plate.

In particular embodiment, the cable management device may be structurally configured as a fiber entry and storage plate.

Embodiments provide a cable management device that may include a base portion and a side portion. The base portion may include an edge connecting portion at an edge of the base portion that may be structurally configured to removably connect to an edge connection portion of an other device; the base portion may include an edge connection portion at an edge of the base portion that may be structurally configured to removably connect to an edge connecting portion of the other device; and the base portion and the side portion may be structurally configured to be removably connected to the other device to provide a modular and scalable cable management system that may permit expandability on demand.

In particular embodiment, the side portion may extend at a positive angle from the base portion.

In particular embodiment, the cable management device may be structurally configured as a cable fixation plate.

In particular embodiment, the cable management device may be structurally configured as a fiber entry and storage plate.

Particular embodiments may further comprise: a fiber entry and retention portion that may include a guide portion that may be structurally configured to receive optical fibers entering the cable management device; a retention portion that may extend from the guide portion and that may be structurally configured to retain the optical fibers in the fiber entry and retention portion; and a fiber storage portion that may be structurally configured to receive and store the optical fibers that have entered the cable management device.

Various aspects of the system, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

FIG. 1 is an upper perspective view of an exemplary cable fixation, entry, storage, and splicing system in accordance with various aspects of the disclosure.

FIG. 2 is an upper perspective view of the cable fixation, entry, storage, and splicing system of FIG. 1.

FIG. 3 is a lower perspective view of the cable fixation, entry, storage, and splicing system of FIG. 1.

FIG. 4 is an exploded perspective view of an exemplary cable fixation plate in accordance with various aspects of the disclosure.

FIG. 5 is a perspective view of a base of the cable fixation plate of FIG. 4.

FIG. 6 is a perspective view of a side panel of the cable fixation plate of FIG. 4.

FIG. 7 is a front perspective view of an exemplary fiber entry and storage plate in accordance with various aspects of the disclosure.

FIG. 8 is a rear perspective view of the fiber entry and storage plate of FIG. 7.

FIG. 9 is a front view a view of the fiber entry and storage plate of FIG. 7.

FIG. 10 is a magnified view of a portion of the fiber entry and storage plate of FIG. 7.

FIG. 11 is a perspective view of a plurality of exemplary tray locks in accordance with various aspects of the disclosure.

FIG. 12 is a magnified view of one of the tray locks of FIG. 11.

FIG. 13 is a perspective view of an alternate exemplary tray lock in accordance with various aspects of the disclosure.

FIG. 14 is a perspective view of a tray stack with a plurality of the cassette lock of FIG. 13 in place.

FIG. 15 is a magnified view of the tray locks shown in FIG. 14.

FIG. 16 is a perspective view of an alternate cable fixation, entry, storage, and splicing system in accordance with various aspects of the invention.

FIG. 17 is a side view of the cable fixation, entry, storage, and splicing system of FIG. 16.

FIG. 18 is a front view of the cable fixation, entry, storage, and splicing system of FIG. 16.

FIG. 19 is a perspective view of an alternate fiber entry and storage plate in accordance with various aspects of the disclosure.

FIG. 20 is a perspective view of the fiber entry and storage plate of FIG. 19.

### DETAILED DESCRIPTION OF EMBODIMENTS

Embodiments of the disclosure provide a modular and scalable platform for managing, storaging and splicing optical fibers. Embodiments provide a number of features which separately and together provide significantly better experience during optical fiber routing, optical fiber splicing, and subsequent management and maintenance of the system. Embodiments provide solutions to problems like splice tray identification, access to optical fibers, expanding the capacity of the system on demand, and other problems.

Embodiments include a cable fixation device in which a base portion and a side portion are structurally configured to be removably connected to another device to provide a modular and scalable cable management system that permits expandabilty on demand.

Embodiments include a fiber entry and storage device in which a base portion and a side portion are structurally configured to be removably connected to another device to provide a modular and scalable cable management system that permits expandabilty on demand.

Embodiments include a fiber management portion connecting device in which a first engaging portion, a second engaging portion, and a connection portion are structurally configured to connect a first fiber management portion to a second fiber management portion such that the first and second fiber management portions are movable as a unit so as to deter a user from contacting optical fibers located between the first and second fiber management portions.

Embodiments include a cable fixation plate the provides multiple points to which cables can be fixed, jackets of the cables can be removed, and fibers of the cables can be broken out so that the fibers can be directed to a fiber entry and storage plate.

Embodiments include a fiber entry and storage plate that provides features for initial fiber entry and guides the fibers from multiple cables to a splice tray mounting plate.

Embodiments include a connection system on the splice trays that provides fixing of the trays one to another, either, for example, two trays to each other, or in blocks, and that provides protection from accidental opening and mistakenly accessing an incorrect splice tray. Embodiments of the connection system provide additional tray identification using, for example, standard cable identification rings or clips.

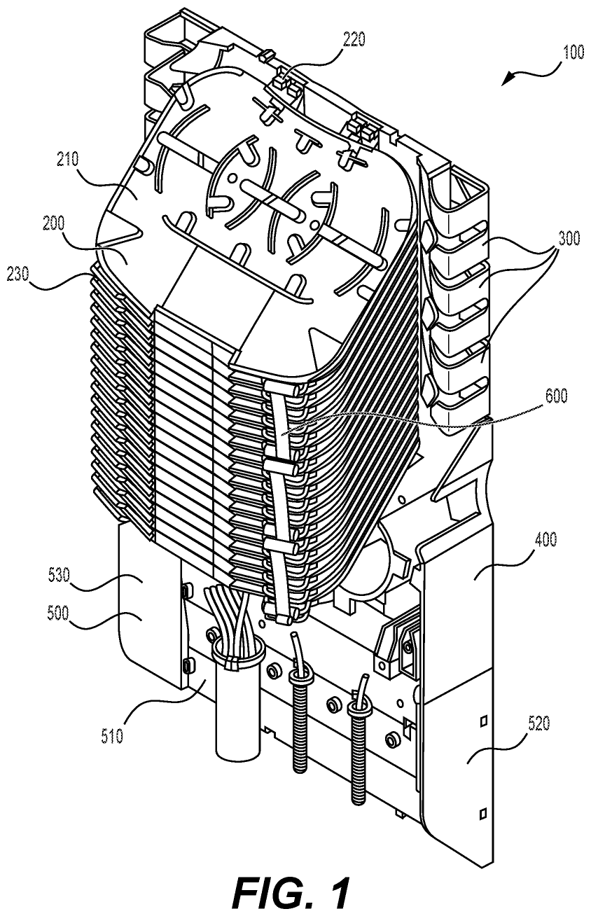

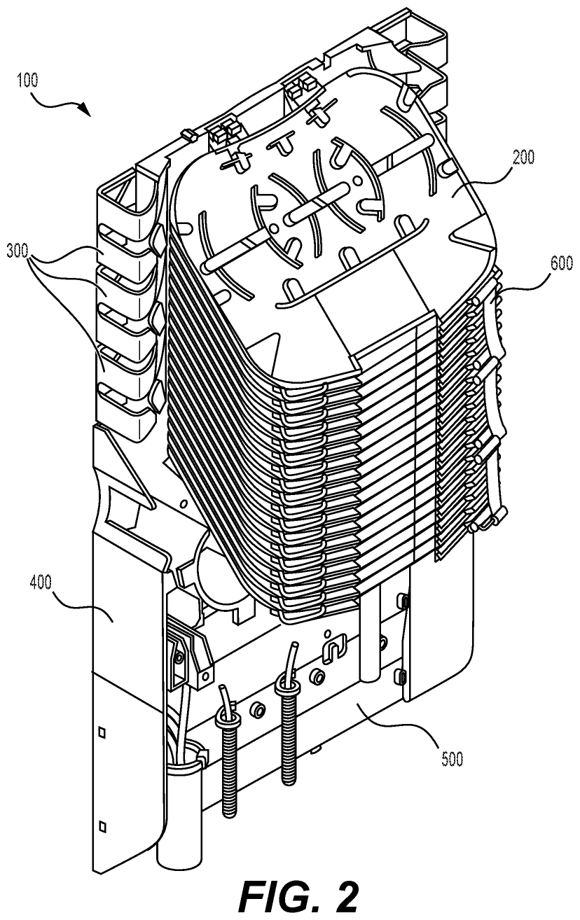

FIGS. 1 and 2 show an exemplary optical fiber cable fixation, entry, storage, and splicing system 100 in accordance with embodiments of the disclosure. System 100 includes, in this example, a plurality of fiber splice portions such as, for example, splice trays (cassettes) 200. In this example, each splice tray 200 has a splicing and fiber management area 210, two connection members 220 that connect splice tray 200 to a splice tray mounting plate 300, and two handles 230 that protrude from a front of splice tray 200. This example includes three fiber splice portion retaining portions such as, for example, splice tray mounting plates 300 to which splice trays 200 are pivotably mounted so that each splice tray 200 can be pivoted upward independently from the other splice trays 200. While this example uses three splice tray mounting plates 300, other examples use fewer or more than three splice tray mounting plates 300. This example includes a fiber entry and storage portion such as, for example, a fiber entry and storage plate 400 that is mounted below, and connected to, a lower-most splice tray mounting plate 300. This example includes a cable fixation portion such as, for example, a cable fixation plate 500 mounted below, and connected to, fiber entry and storage plate 400. The various components of system 100 are discussed in detail below.

In some installment locations, multiple systems 100 are mounted beside each other and/or on top of one another (with or without an intervening mounting plate) to increase density within a cabinet or other panel. For example, a side wall 530 of a first system 100 can be located adjacent to a side wall 520 of another system 100, and/or a base plate 510 of one system 100 can be mounted to an intervening mounting plate that is, in turn attached to a base plate 510 of another system 100.

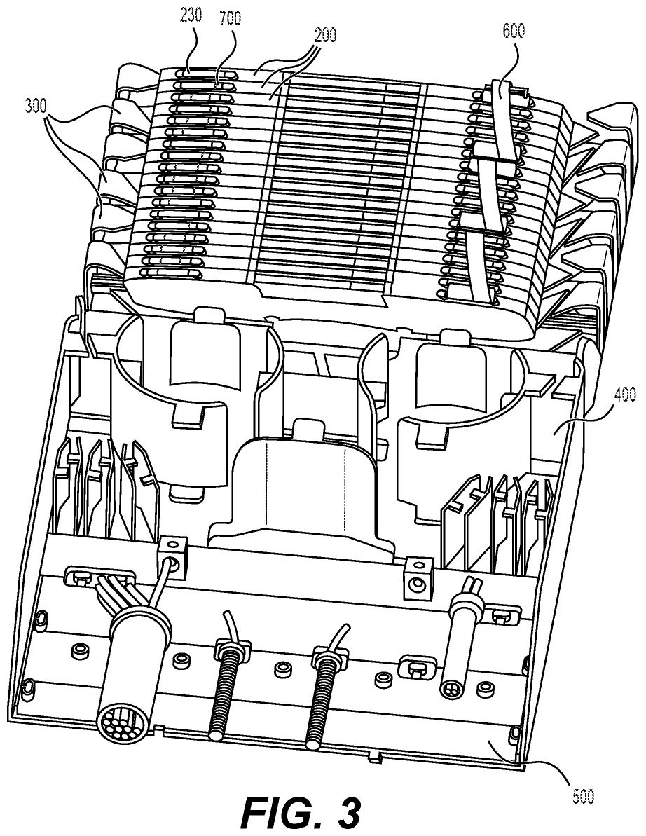

FIG. 3 is a perspective view of system 100 looking up from the bottom of system 100 and shows the interconnection between splice tray mounting 300 and fiber entry and storage plate 400. FIG. 3 also shows the interconnection between fiber entry and storage plate 400 and cable fixation plate 500.

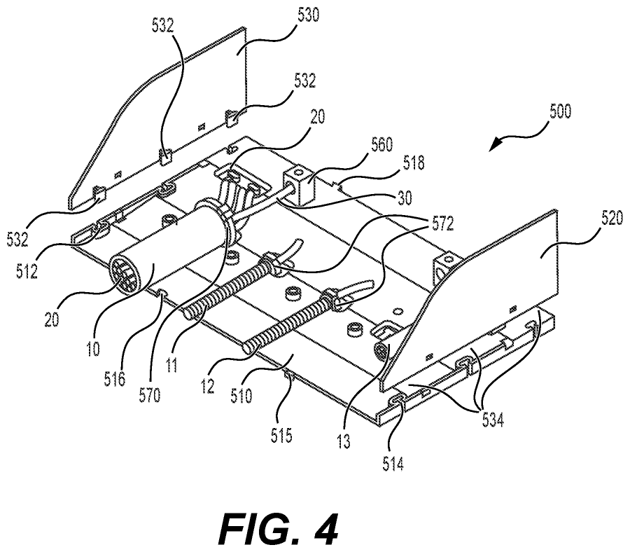

FIGS. 4-6 show an example of cable fixation plate 500. In this example, cable fixation plate 500 has a base portion such as, for example, a base plate 510, and two side portions such as, for example, side walls 520, 530 that are removably connected to base plate 510. Cable fixation plate 500 provides multiple points where incoming cables can be fixed to system 100. Base plate 510 of cable fixation plate 500 has, in this example, three side portion mounting portions such as, for example, receiving recesses 512, 514 on each side that are configured to receive base portion engaging portions such as, for example, base plate engaging portions or locking lugs 532, 534 located on side walls 530, 520, respectively. In this example, receiving recesses 512, 514 are T-shaped to receive T-shaped locking lugs 532, 534. In this embodiment, locking lugs 432, 534 snap into receiving recesses 512, 514 with a snap-fit connection and are held in place by a friction fit. Other embodiments have different shaped receiving recesses and locking lugs that secure side walls 510, 520 to base plate 510. Side walls 520, 530 provide separation and containment of the cables 10, 11, 12, 13 such that cables 10, 11, 12, 13 cannot contact cables entering other adjacent systems 100.

As shown in FIG. 4, a cable 10 having a plurality of optical fibers 20 can be anchored to base plate 510 by a cable tie 570 at one of a plurality of securing portions such as, for example, T-slots 540 to secure cable 10 to base plate 510. Similarly, cables 11, 12 having a single optical fiber can be anchored to base plate 510 by a cable retaining portion such as, for example, a cable tie 572 at one of T-slots 540 to secure cables 11, 12 to base plate 510. FIG. 4 also shows a cable 13 anchored to base plate 510 at one of a plurality of T-slots 550. One or more anchors 560 provide a connection point for a structural member 30 that is included in many cables 10. Anchor 560 clamps onto structural member 30 by, for example, a set screw or other fixing member. By fixing structural member 30 of cable 10 to base plate 510, tension and/or other stresses on optical fibers 20 are reduced or eliminated.

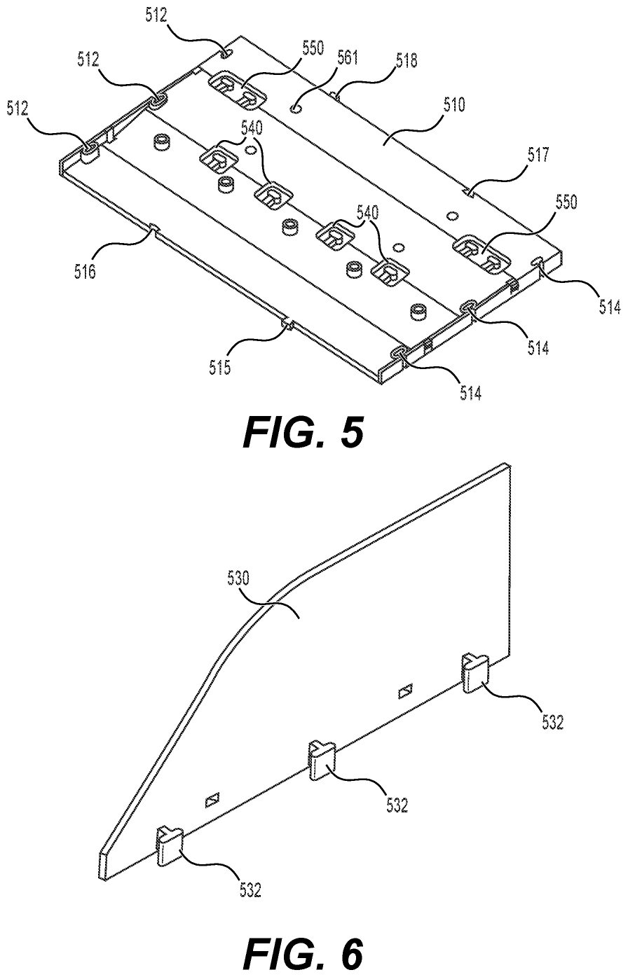

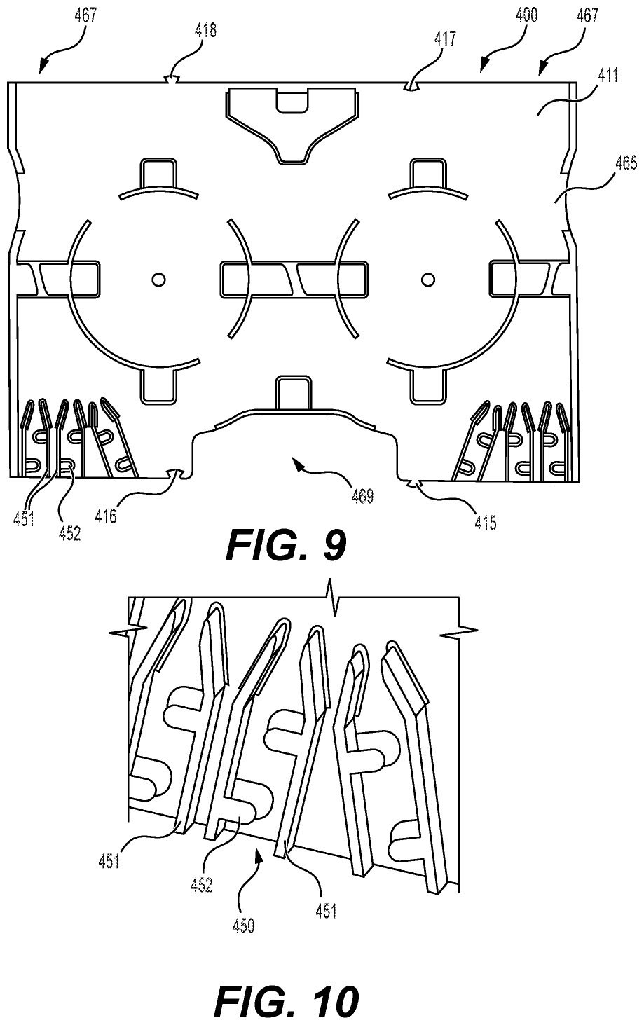

FIGS. 4 and 5 show edge connection portions such as, for example, connection tabs 515, 518 and edge connecting portions such as, for example, connection recesses 516, 517 on edges of base plate 510. Connection tab 515 is configured to be received by connection recess 517 of a second base plate 510 in the case of two cable fixation plates 500 being stacked vertically in system 100. Two of more cable fixation plates 500 can be used if the number of cables coming into system 100 exceeds the number of cable securing portions such as, for example, T-slots 540, 550 provided on one cable fixation plate 500. Also, connection tab 518 and connection recess 517 are structurally configured to connect to a edge connecting portion such as, for example, connection recess 416 and a edge connection portion such as, for example, connection tab 415, respectively, on fiber entry and storage plate 400 (shown in FIGS. 8 and 9), to connect an upper most cable fixation plate 500 to a lower edge of fiber entry and storage plate 400 (as shown in FIGS. 1-3).

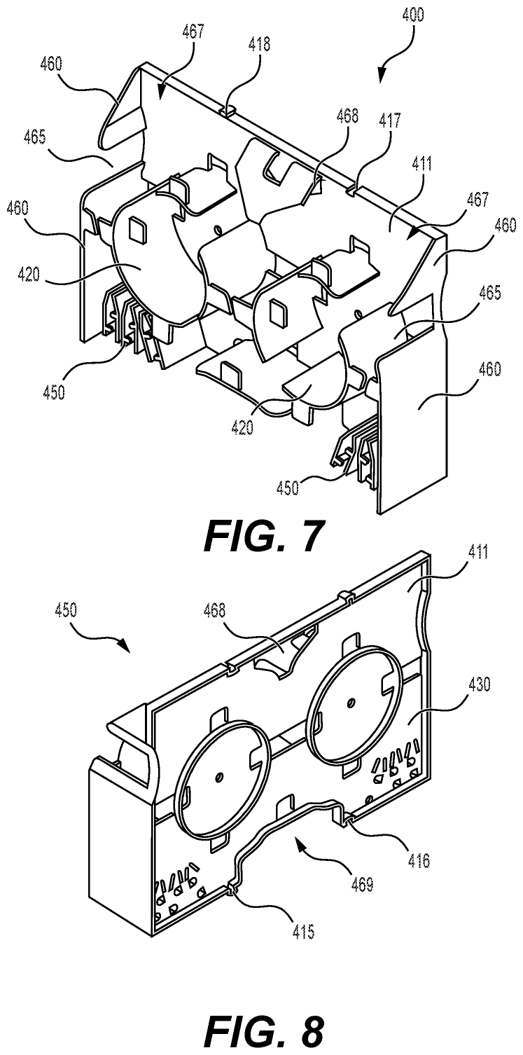

FIGS. 7-10 show an exemplary fiber entry and storage portion such as, for example, a fiber entry and storage plate 400 that provides a transition location between an uppermost cable fixation plate 500 and a lower-most splice tray mounting plate 300. Fiber entry and storage plate 400 has a front portion such as, for example, a front side 410 and a rear portion such as, for example, a rear side 430. Fiber entry and storage plate 400 has a base portion such as, for example, a base plate 411 and two side portions such as, for example, side walls 460 structurally configured to extend forward from base plate 411. Multiple fiber entry and storage plates 400 can be used on one system 100 if needed. In this example, fiber entry and storage plate 400 has edge connection portions such as, for example, connection tabs 415, 418 and edge connecting portions such as, for example, connection recesses 416, 417 on edges of base plate 411. Connection tab 415 is structurally configured to be received by connection recess 517 of an upper-most cable fixation plates 500 located below fiber entry and storage plate 400. Similarly, connection recess 416 is structurally configured to receive connection tab 518 of the upper-most cable fixation plate 500. Connection tab 418 is structurally configured to be received by a connection recess of a lower-most splice tray mounting plate 300 located above fiber entry and storage plate 400. Similarly, connection recess 417 is configured to receive a connection tab of the lower-most splice tray mounting plate 300. In installations that include more than one fiber entry and storage plate 400, connection tabs 415, 418 and connection recesses 416, 417 on adjacent fiber entry and storage plates 400 are structurally configured to interconnect to secure the adjacent fiber entry and storage plates 400 to each other.

In this example, fiber entry and storage plate 400 has a plurality of fiber entry and retention portions such as, for example, fiber entry and retention areas 450 (shown in more detail in FIG. 10) that include guide portions such as, for example, guide walls 451 between which optical fibers entering fiber entry and storage plate 400 are located. One or more fiber retention portions such as, for example, retention tabs 452 are provided to help retain the fibers in the area between guide walls 451. One or more fibers can be located between each pair of guide walls 451.

One or more fiber storage portions such as, for example, fiber spools 420 are structurally configured to provide a place to wrap and store fibers that have entered fiber entry and storage plate 400 through fiber entry and retention areas 450 (and/or other areas). Side pathway portions such as, for example, side openings 465 provide a path for fibers and/or cables to pass from one fiber entry and storage plate 400 to an adjacent fiber entry and storage plate 400 located at its side. Fibers pass out of fiber entry and storage plate 400 at locations 467 and into one or more splice tray mounting plates 300 located above fiber entry and storage plate 400. A rear passage portion such as, for example, rear passage 468 is provided to allow fibers and/or cables to pass from front side 410 to rear side 430 of fiber entry and storage plate 400. A lower passage portion such as, for example, lower passage 469 is provided to allow fibers and/or cables to pass from front side 410 to rear side 430 of fiber entry and storage plate 400. Rear passage 468 and lower passage 469 provide paths for fibers and/or cables to pass between one fiber entry and storage plate 400 and another fiber entry and storage plate 400 mounted either in front of, or behind, it.

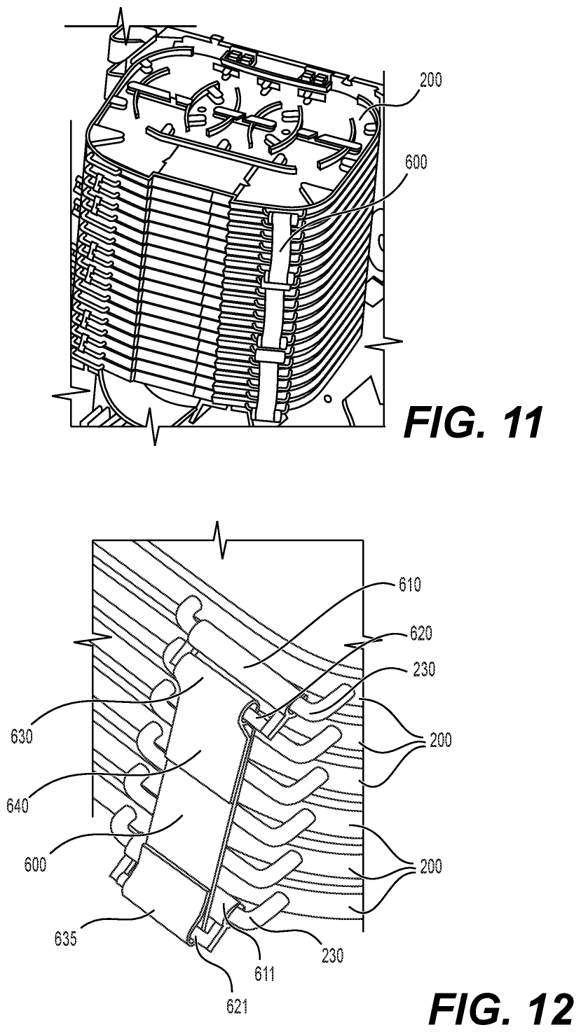

FIGS. 11 and 12 show an exemplary embodiment of a fiber splice portion connecting portion such as, for example, a tray lock 600 that is structurally configured to lock a plurality of fiber management portions such as, for example, splice trays 200 together. It is useful to lock multiple splice trays 200 together if they are related in some way. For example, a group of splice trays 200, such as the six splice trays 200 shown in FIG. 12, may be related in that they all splice fibers coming from a single cable or they all splice fibers going to a single floor in a multiple dwelling unit. A group of splice trays may also be grouped and locked together to help prevent unintentional access by a technician.

In this example, splice trays 200 have one or more gripping portions such as, for example, handles 230 that are structurally configured to extend from a front edge of splice tray 200. Tray lock 600 has an engaging portion such as, for example, a snap connector 610 that snaps onto, or otherwise engages or connects to, handle 230 of one splice tray 200, and an engaging portion such as, for example, a snap connector 611 that snaps onto, or otherwise engages or connects to, handle 230 of another splice tray 200. Snap connector 610 has a connection portion receiving portion such as, for example, a strap receiving member 620 that is structurally configured to receive an end portion such as, for example, an end 630 of a connection portion such as, for example, a strap 640 such that strap 640 is attached to snap connector 610. Snap connector 611 has a connection portion receiving portion such as, for example, a strap receiving member 621 that is configured to receive an end portion such as, for example, an end 635 of strap 640 such that strap 640 is attached to snap connector 611. In embodiments, one or both ends 630, 635 of strap 640 are structurally configured with hook and loop fasteners so that the length of strap 640 is adjustable. The adjustability of the length of strap 640 allows tray lock 600 to be adjusted to lock together different numbers of splice trays 200. For example, tray lock 600 is structurally configured to be shortened or lengthened from the length shown in FIG. 12 to lock three, eight, or some other number of splice trays 200 together.

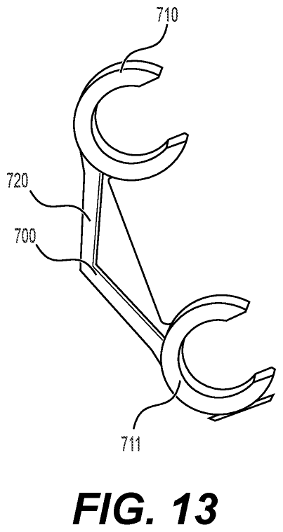

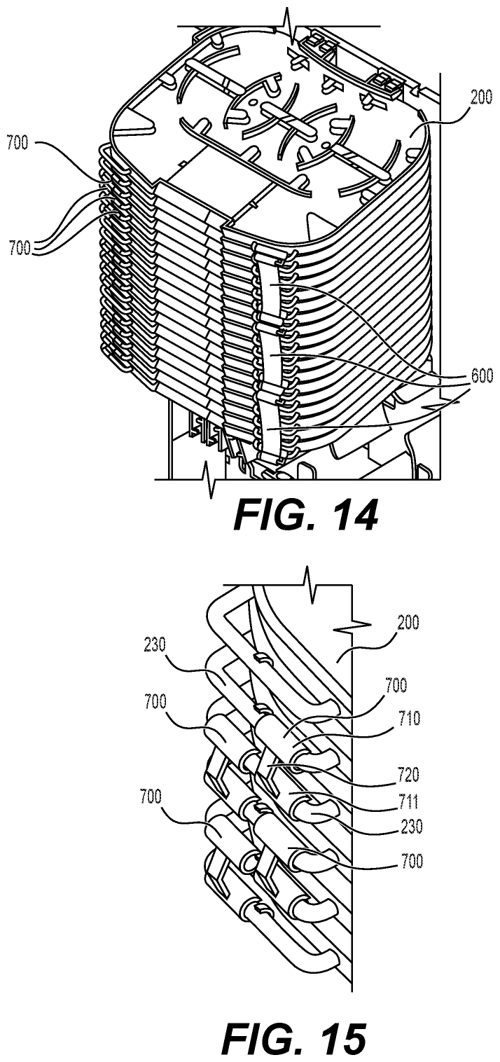

FIGS. 13-15 show another exemplary embodiment of a fiber splice portion connecting portion such as, for example, a tray lock. A fiber splice portion connecting portion such as, for example, a tray lock 700 is structurally configured to have a fixed length and, unlike tray lock 600, is not adjustable. Tray lock 700 has a gripping portion engaging portion such as, for example, a snap clip 710 at one end and a gripping portion engaging portion such as, for example, a snap clip 711 at its other end. Snap clips 710, 711 are connected by a main portion such as, for example, a main body 720. As shown in FIG. 15, tray lock 700 locks two adjacent splice trays 200 together by clipping onto handles 230. The embodiment shown in FIG. 15 has a main body 720 sized to bridge the gap between two adjacent splice trays 200. However, other embodiments have a main body 720 sized to clip on to handles 230 of two splice trays 200 that are separated by one or more additional splice trays 200.

In embodiments, tray locks 600 and tray locks 700 have indicia that provide information as to the group of splice trays locked together. For example, in embodiments, tray lock 600 or 700 is a certain color to indicate a particular signal source and/or terminal location of the optical fiber. In embodiments, strap 640 includes a number of stripes or other markings of one or more colors and/or an alpha-numeric indicator. In embodiments, one or both of snap connectors 610, 611 includes a number of stripes or other markings of one or more colors and/or an alpha-numeric indicator. In embodiments, main body 720 and/or one or both of snap clips 710, 711 includes a number of stripes or other markings of one or more colors and/or an alpha-numeric indicator. Embodiments include other combinations of markings and/or colors and/or textures to differentiate one group of coupled splice trays from another group of coupled splice trays.

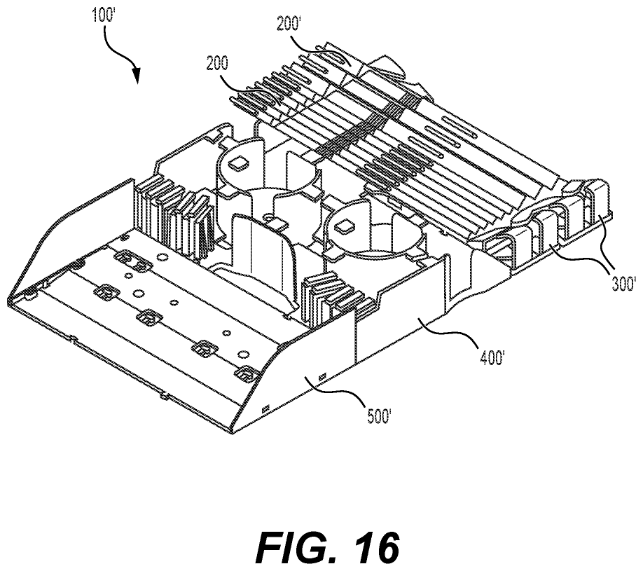

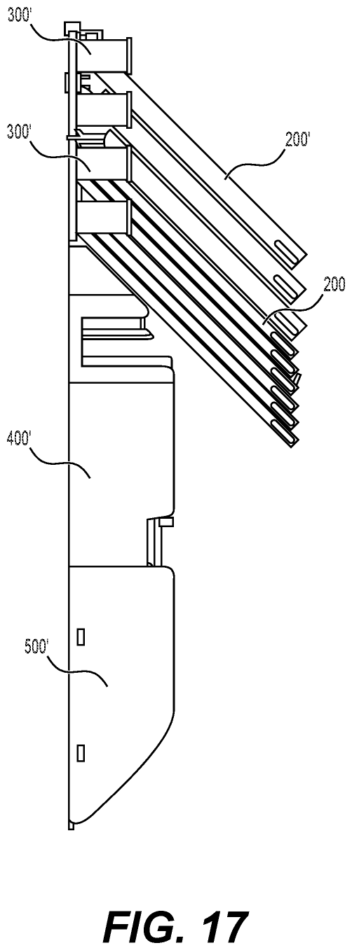

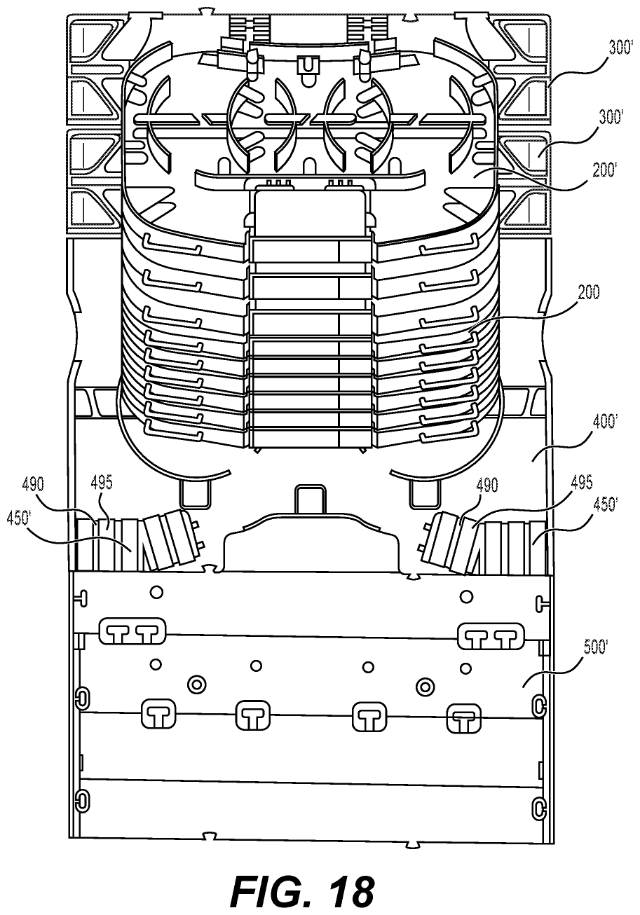

FIGS. 16-18 show an alternate embodiment including a plurality of splice trays 200, 200′. Two splice tray mounting plates 300′ to which splice trays 200, 200′ are pivotably mounted so that each splice tray 200, 200′ can be pivoted upward independently from the other splice trays 200, 200′. While this example uses two splice tray mounting plates 300′, other examples use fewer or more than two splice tray mounting plates 300′. This example includes a fiber entry and storage plate 400′ that is mounted below, and connected to, a lower-most splice tray mounting plate 300′. This example includes a cable fixation plate 500′ mounted below, and connected to, fiber entry and storage plate 400′.

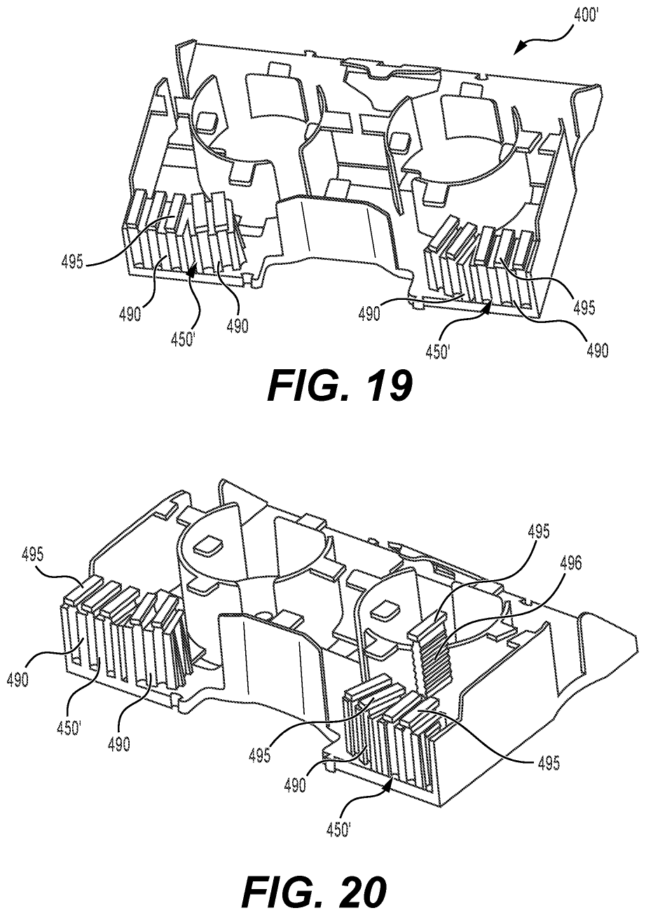

FIGS. 19 and 20 show fiber entry and storage plate 400′ as having features similar to those of fiber entry and storage plate 400. However, fiber entry and storage plate 400′ has a plurality of locator portions such as, for example, walls 490 in retention areas 450′ that form areas that are structurally configured to receive fiber guide portions such as, for example, optical fiber guide plates 495. In this example, optical fiber guide plates 495 have a plurality of fiber receiving portions such as, for example, grooves 496 that each receive one optical fiber. In embodiments, optical fiber guide plate 495 slides laterally between two walls 490 and snaps into place to remain between the two walls 490. In other embodiments, optical fiber guide plate 495 slides down between two walls 490 perpendicular to a back wall of fiber entry and storage plate 400′ and snaps into place to remain between the two walls 490.

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

Various changes to the foregoing described and shown structures will now be evident to those skilled in the art. Accordingly, the particularly disclosed scope of the invention is set forth in the following claims.

What is claimed is:

1. A cable management device comprising:
a base portion;
a side portion;
wherein the base portion includes an edge connecting portion at an edge of the base portion that is structurally configured to removably connect to an edge connection portion of an other device;
wherein the base portion includes an edge connection portion at an edge of the base portion that is structurally configured to removably connect to an edge connecting portion of the other device;
wherein the edge connecting portion is structurally configured as a connection recess;
wherein the edge connection portion is structurally configured as a connection tab;
wherein the base portion is structurally configured as a base plate;
wherein the side portion is structurally configured as a side wall;
wherein the side portion extends at a positive angle from the base portion; and
wherein the base portion and the side portion are structurally configured to be removably connected to the other device to provide a modular and scalable cable management system that permits expandability on demand.

2. The cable management device of claim 1, wherein the base portion includes a securing portion that is structurally configured to receive a cable securing portion to secure an optical cable to the base portion.

3. The cable fixation device of claim 2, wherein the securing portion is structurally configured as a T-slot.

4. The cable management device of claim 1, further comprising:
a fiber entry and retention portion including a guide portion that is structurally configured to receive optical fibers entering the cable management device;
a retention portion extending from the guide portion and that is structurally configured to retain the optical fibers in the fiber entry and retention portion; and
a fiber storage portion that is structurally configured to receive and store the optical fibers that have entered the cable management device.

5. The cable management device of claim 4, wherein the guide portion is structurally configured as a guide wall.

6. The cable management device of claim 4, wherein the retention portion is structurally configured as a retention tab.

7. The cable management device of claim 4, wherein the fiber storage portion is structurally configured as a fiber spool.

8. The cable management device of claim 1, further comprising a side pathway portion that is structurally configured to provide a path for optical fibers to pass from the base portion to an adjacent cable management device;
a rear passage portion that is structurally configured to allow passage of the optical fibers from a front side of the base portion to a rear side of the base portion; and
a lower passage portion that is structurally configured to allow passage of the optical fibers from the front side of the base portion to the rear side of the base portion.

9. The cable management device of claim 1, wherein the side portion extends at a positive angle from the base portion.

10. The cable management device of claim 1, wherein the cable management device is structurally configured as a cable fixation plate.

11. The cable management device of claim 1, wherein the cable management device is structurally configured as a fiber entry and storage plate.

12. A cable management device comprising:
a base portion;
a side portion;
wherein the base portion includes an edge connecting portion at an edge of the base portion that is structurally configured to removably connect to an edge connection portion of an other device;
wherein the base portion includes an edge connection portion at an edge of the base portion that is structurally configured to removably connect to an edge connecting portion of the other device;
wherein the edge connecting portion is structurally configured as a connection recess;
wherein the edge connection portion is structurally configured as a connection tab; and
wherein the base portion and the side portion are structurally configured to be removably connected to the other device to provide a modular and scalable cable management system that permits expandability on demand.

13. The cable management device of claim 12, wherein the base portion includes a securing portion that is structurally configured to receive a cable securing portion to secure an optical cable to the base portion.

14. The cable management device of claim 12, wherein the securing portion is structurally configured as a T-slot.

15. The cable management device of claim 12, further comprising:
a fiber entry and retention portion including a guide portion that is structurally configured to receive optical fibers entering the cable management device;
a retention portion extending from the guide portion and that is structurally configured to retain the optical fibers in the fiber entry and retention portion; and
a fiber storage portion that is structurally configured to receive and store the optical fibers that have entered the cable management device.

16. The cable management device of claim 12, further comprising a side pathway portion that is structurally configured to provide a path for optical fibers to pass from the base portion to an adjacent cable management device;
a rear passage portion that is structurally configured to allow passage of the optical fibers from a front side of the base portion to a rear side of the base portion; and
a lower passage portion that is structurally configured to allow passage of the optical fibers from the front side of the base portion to the rear side of the base portion.

17. The cable management device of claim 12, wherein the side portion extends at a positive angle from the base portion.

18. The cable management device of claim 12, wherein the cable management device is structurally configured as a cable fixation plate.

19. The cable management device of claim 12, wherein the cable management device is structurally configured as a fiber entry and storage plate.

20. A cable management device comprising:
a base portion;
a side portion;
wherein the base portion includes an edge connecting portion at an edge of the base portion that is structurally configured to removably connect to an edge connection portion of an other device;
wherein the base portion includes an edge connection portion at an edge of the base portion that is structurally configured to removably connect to an edge connecting portion of the other device; and
wherein the base portion and the side portion are structurally configured to be removably connected to the other device to provide a modular and scalable cable management system that permits expandability on demand.

21. The cable management device of claim 20, wherein the side portion extends at a positive angle from the base portion.

22. The cable management device of claim 20, wherein the cable management device is structurally configured as a cable fixation plate.

23. The cable management device of claim 20, wherein the cable management device is structurally configured as a fiber entry and storage plate.

24. The cable management device of claim 23, further comprising:
a fiber entry and retention portion including a guide portion that is structurally configured to receive optical fibers entering the cable management device;
a retention portion extending from the guide portion and that is structurally configured to retain the optical fibers in the fiber entry and retention portion; and
a fiber storage portion that is structurally configured to receive and store the optical fibers that have entered the cable management device.
